(19) United States
(12) Patent Application Publication
(10) Pub. No.: US 2008/0146197 A1
(43) Pub. Date: Jun. 19, 2008

(54) METHOD AND DEVICE FOR EMITTING AN AUDIBLE ALERT

(75) Inventor: Woan Chyau Lim, Singapore (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/610,996

(22) Filed: Dec. 14, 2006

(51) Int. Cl. H04Q 7/22

(52) U.S. Cl. 455/412.2

(57) ABSTRACT

A method and wireless communication device for emitting an audible alert synthesizes speech using vocal parameters of a caller or of a sender of an electronic message. A vocal parameter and a pre-defined phrase associated with an incoming communication signal are identified (block 515). Speech is then synthesized using the vocal parameter and the pre-defined phrase to emit the audible alert over a speaker associated with the wireless communication device (block 520).

### FIELD OF THE INVENTION

The present invention relates generally to wireless communication devices, and in particular to audible alerts comprising synthesized speech concerning incoming communication signals.

### BACKGROUND

Since the advent of the telephone in the early twentieth century, users have been alerted to the presence of an incoming call usually by a ring sound. Early telephones incorporated a mechanical bell into a telephone housing. An incoming call then triggered an electrical solenoid that actuated the bell. More recently, telephones have incorporated electronic ringing devices that output a ring sound through a speaker. Many telephones still use a traditional ring pattern however consisting of a series of brief, staccato monotone sounds interrupted by approximately equal periods of silence.

The mobile telephone was first introduced in 1946, but gained wide commercial acceptance only in the 1990's. Today, consumers increasingly use wireless service as their sole telephone access method. The recent rapid growth of wireless telephone use was accompanied by many related innovations including SMS messaging and digital wireless internet access through mobile telephones. Another innovation was a change away from the standard monotone telephone ring to various diverse ring tones including music and other electronic sounds.

Mobile telephones now offer users the option of selecting their own personalized ring tones. Often these tones are selectable from a menu on the telephone and include a list of preprogrammed sounds provided by the manufacturer. Further, digital wireless telephones allow users to download segments of music that can be played as ring tones. Such music segments are referred to as polyphonic ring tones. Users can then program their phones to associate a particular polyphonic ring tone with a particular caller, effectively using ring tones as an audio caller ID feature.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a wireless communication device in the form of a mobile telephone, according to some embodiments of the present invention.

FIG. 2 is a diagram illustrating a contact details display for an individual listed in a telephone number database of a wireless communication device, according to some embodiments of the present invention.

FIG. 3 is a diagram illustrating a vocal details display, which is for example a continuation of the contact details display shown in FIG. 2, for an individual listed in a telephone number database of a wireless communication device, according to some embodiments of the present invention.

FIG. 4 is a diagram illustrating a ring tone styles display, according to some embodiments of the present invention.

FIG. 5 is a general flow diagram illustrating a method for emitting an audible alert on a wireless communication device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and device for emitting an audible alert. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

According to one aspect, the present invention is a method for emitting an audible alert on a wireless communication device such as a mobile telephone or personal digital assistant (PDA). Such a method includes identifying a vocal parameter and a pre-defined phrase associated with an incoming communication signal. Speech is then synthesized using the vocal parameter and the pre-defined phrase to emit the audible alert over a speaker associated with the wireless communication device. Thus, rather than associating a particular polyphonic ring tone such as a music file with a particular caller, as known according to the prior art, embodiments of the present invention enable a simulated voice of a caller to be used as a ring tone and audio caller ID feature. By simulating actual voice characteristics of a caller, or of a sender of an electronic message, the present invention enables a user of an electronic communication device to immediately recognize the identity of the caller or sender. That is because the user may instantly and intuitively recognize a voice signature of the caller or sender, even before hearing or comprehending all the words of a pre-defined phrase uttered as the audible alert.

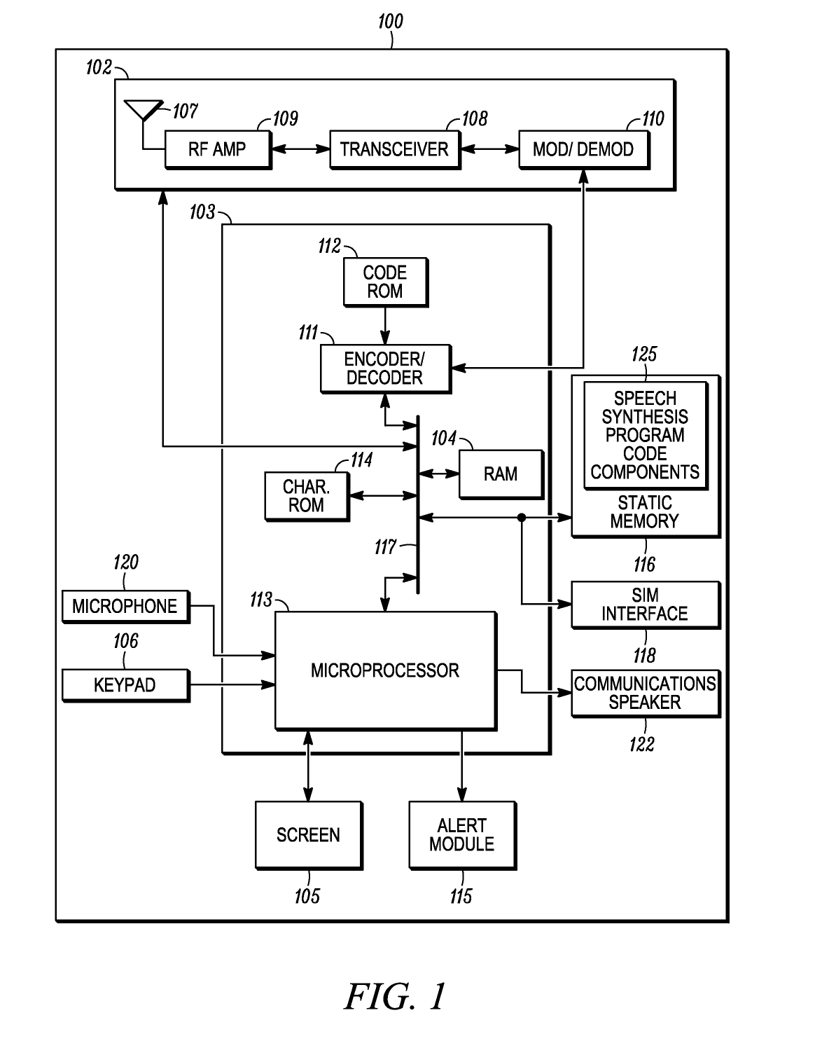

Referring to FIG. 1, a schematic diagram illustrates a wireless communication device in the form of a mobile telephone 100, according to some embodiments of the present invention. The telephone 100 comprises a radio frequency communications unit 102 coupled to be in communication with a common data and address bus 117 of a processor 103. The telephone 100 also has a keypad 106, and a display screen 105, such as a touch screen coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116 and a Subscriber Identity Module (SIM) interface 118. The programmable memory 116 and a SIM operatively coupled to the SIM interface 118 each can store, among other things, selected text messages and a telephone number database comprising a number field for telephone numbers and a name field for identifiers associated with one of the numbers in the name field.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers, to a microphone 120 and to a communications speaker 122. The character ROM 114 stores code for decoding or encoding data such as text messages that may be received by the communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise speech synthesis computer readable program code components 125 configured to cause execution of a method for emitting a synthesized speech audible alert, according to an embodiment of the present invention. Various methods for emitting an audible alert, according to different embodiments of the present invention, are described in detail below.

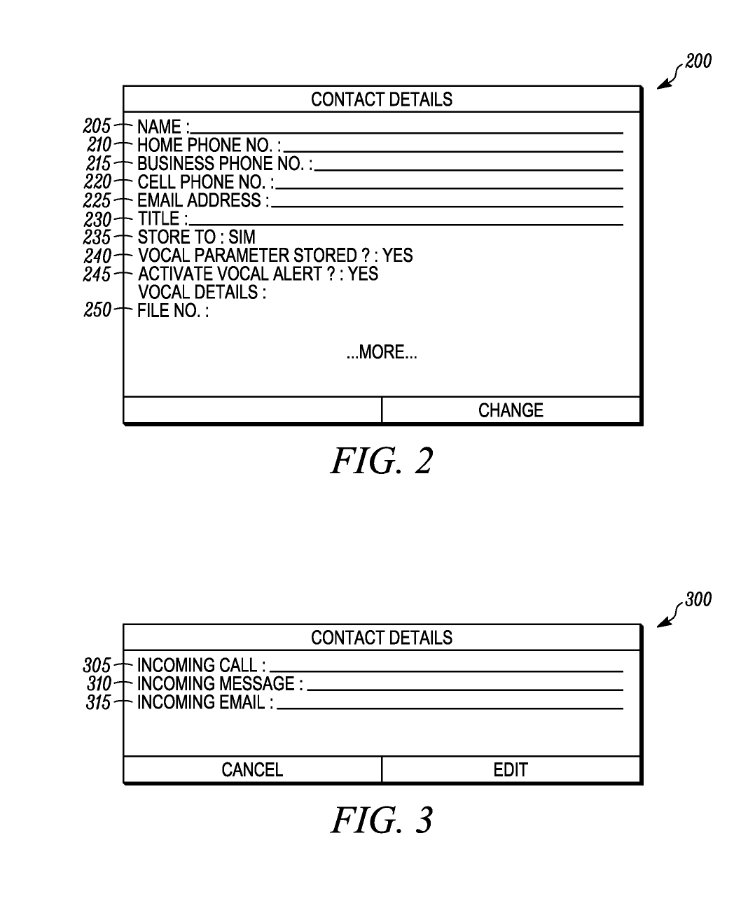

Referring to FIG. 2, a diagram illustrates a contact details display 200 for an individual listed in a telephone number database of a wireless communication device, according to some embodiments of the present invention. For example, the contact details display 200 can be presented on the display screen 105 of the mobile telephone 100, and provide information stored in a SIM that is operatively coupled to the SIM interface 118. The contact details display 200 may include, for example, at line 205 a name of an individual, at line 210 the home phone number of the individual, at line 215 the business phone number of the individual, at line 220 the cell phone number of the individual, at line 225 the email address of the individual, and at line 230 the title of the individual. Further, the contact details display 200 may include at line 235 the location where contact details for the individual are stored, such as in a SIM or in the programmable memory 116 of the mobile telephone 100. At line 240, the contact details display 200 indicates whether a vocal parameter for the individual is stored. At line 245, the contact details display 200 indicates whether a vocal alert for the individual is activated.

According to some embodiments of the present invention, if an incoming communication signal is received from a source that is associated with an individual named in a telephone number database of the mobile telephone 100, and a vocal parameter for the individual is stored (such as indicated by line 240 of the contact details display 200), and a vocal alert for the individual is activated (such as indicated by line 245 of the contact details display 200), then an audible alert comprising synthesized speech that emulates the voice of the individual is emitted from the mobile telephone 100. For example, the audible alert may be simply the name of the individual that is emitted as synthesized speech over the communications speaker 122 or over a speaker of the alert module 115.

The audible alert thus can be considered as a synthesized speech ring tone and caller ID feature. The vocal parameter that is used to synthesize speech that emulates an individual identified in the contact details display 200 can be a multi-variable parameter that includes, for example, a frequency variable and a pitch variable associated the individual's voice. Such variables also can be stored in a file of a telephone number database. Thus, for example, line 250 of the contact details display 200 can identify a file that includes a frequency variable and pitch variable associated with an individual's voice.

Referring to FIG. 3, a diagram illustrates a vocal details display 300 that is for example a continuation of the contact details display 200 for an individual listed in a telephone number database of a wireless communication device, according to some embodiments of the present invention. The vocal details display 300 can include pre-defined phrases that are used in an audible alert. For example, if the contact details display presents information about a spouse of a user of the mobile telephone 100, the user might enter a pre-defined phrase at line 305 such “honey, it's me.” If a phone call is then received at the mobile telephone 100 from a phone number associated in the telephone number database with the spouse, the mobile telephone 100 will emit synthesized speech enunciating “honey, it's me”, rather than playing a conventional ring tone. The speech synthesis uses a vocal parameter associated with the spouse so as to simulate the spouse's voice. Similarly, a different pre-defined phrase can be identified at line 310, which phrase is enunciated when an incoming text or multimedia message is received from a source identified in the contact details display 200. Further, yet another pre-defined phrase can be identified at line 315, which phrase is enunciated when an incoming email is received from a source identified in the contact details display 200. For example, concerning a user's spouse, such a pre-defined phrase can be “honey, check your email.”

The vocal parameter that is used to synthesize speech for an audible alert can be obtained in various ways, according to some embodiments of the present invention. For example, if a “vocal parameter stored?” field at line 240 is set to “No” concerning a particular individual identified in the contact details display 200, then the mobile telephone 100 can be programmed to automatically analyze an incoming voice signal when a telephone call is either made to or received from one of the telephone numbers associated with that particular individual. Thus a vocal parameter can be defined by analyzing a voice signal of a caller or callee. The vocal parameter is essentially a voice signature and can comprise, for example, a vocal frequency, a vocal pitch, or various other variables used to define the characteristics of an individual's voice. According to such an embodiment, no recording of a voice signal needs to be made, and a caller or callee does not even need to be aware that their voice signal is being analyzed. Further, storing a vocal parameter that defines a voice signature, rather than storing an audio voice recording, requires significantly less memory.

Voice signal analysis techniques and vocal parameters used to implement embodiments of the present invention are well known by those skilled in the art. For example, various techniques are known for rapidly capturing a voice signature from a short sample utterance and defining such a signature using variables such as pitch mean, pitch range, intonation patterns, volume, frequency, and speaking rate. Further, various types of text-to-speech (TTS) systems that are well known in the art can be used to synthesize speech according to the teachings of the present invention. For example, various diphone synthesis, formant synthesis, articulatory synthesis, or Hidden Markov Model (HMM) based synthesis techniques can be used according to various embodiments of the present invention.

Thus, according to some embodiments of the present invention, the microprocessor 113 of the mobile telephone 100 can sample and process, for example, a four second segment of a voice signal of a caller that is received from the encoder/decoder 111. Using linear predictive coding (LPC) parameterization techniques, such as those well known in the art, the microprocessor 113 then defines a vocal parameter of the caller including, for example, pitch range, intonation pattern, frequency and speaking rate variables, and saves the vocal parameter in the programmable memory 116. Thereafter, when a call or message is received from the same caller at the mobile telephone 100, a formant synthesis algorithm stored as program code components in, for example, the Read Only Memory (ROM) 112, is employed by the microprocessor 113 to synthesize speech using the vocal parameter stored in the programmable memory 116. The synthesized speech is then amplified over the communications speaker 122 as an audible alert.

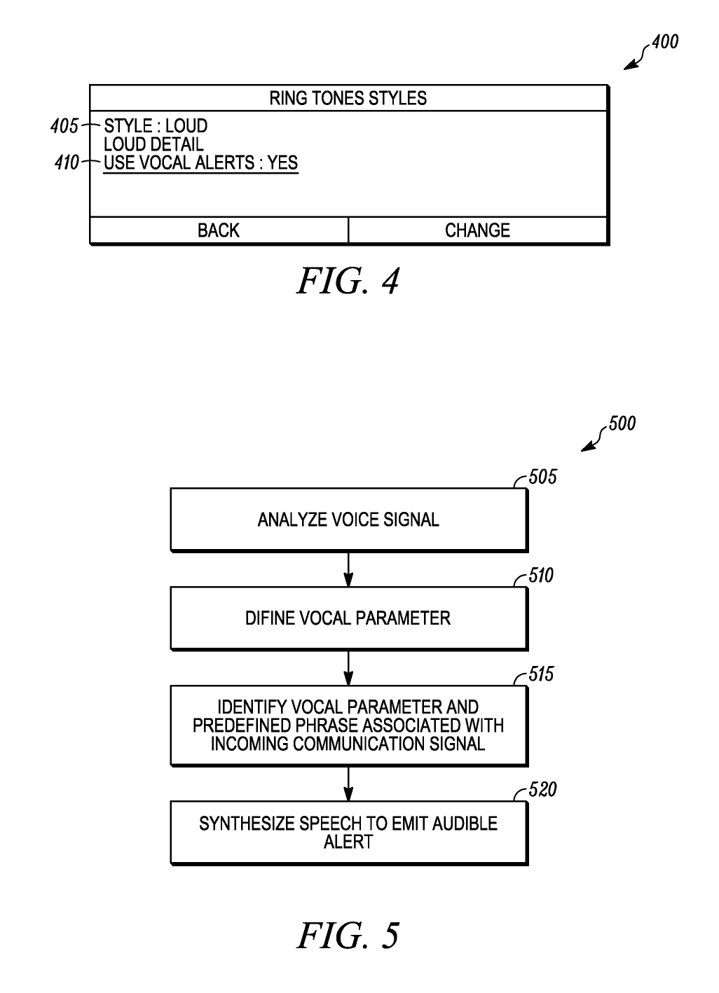

Referring to FIG. 4, a diagram illustrates a ring tone styles display 400, according to some embodiments of the present invention. The ring tone styles display 400 can be displayed for example as a menu on the display screen 105 of the mobile telephone 100. A user of the mobile telephone 100 then can use the ring tone styles display 400 to select specific ring tones, such as musical ring tones, or indicate that audible alerts using synthesized speech, according to the teachings of the present invention, should be activated. For example, at line 405, a user can select loud or soft volume levels for ring tones, and at line 410 a user can select whether vocal alerts using synthesized speech should be activated. According to other embodiments of the present invention, the ring tone styles display 400 can be used to select default pre-defined phrases for use as audible alerts. For example, if a user of the mobile telephone 100 has not entered specific pre-defined phrases at lines 305, 310, or 315 of the vocal details display 300 for some individuals listed in a telephone number database, or if such pre-defined phrases have been entered but a user seeks to override them, the user can employ the ring tone styles display to enter and select default pre-defined phrases. Such default pre-defined phrases can for example conform to simple formulas such as “incoming call from [name]”, or “incoming email from [name]”, which pre-defined phrases are synthesized using a particular individual's vocal parameter stored in the mobile telephone 100.

Referring to FIG. 5, a general flow diagram illustrates a method 500 for emitting an audible alert on a wireless communication device, according to some embodiments of the present invention. At block 505, a voice signal of a caller or callee is analysed. For example, a voice analysis technique that is well-known in the art is used to analyse either the voice of a caller to the mobile telephone 100 or the voice of a callee that is received as a voice signal after a call is placed from the mobile telephone 100.

At block 510, a vocal parameter based on the voice signal of the caller or callee is defined. For example, as described above, the vocal parameter can be a multi-variable parameter including variables such as a vocal frequency and a vocal pitch to define a voice signature that enables an audible voice to be synthesized so as to emulate vocal characteristics of the caller or callee. The vocal parameter then can be stored at the wireless communication device so that it can be used to generate an audible alert the next time the caller or callee transmits an incoming communication signal to the wireless communication device.

At block 515, the vocal parameter and a pre-defined phrase, both associated with an incoming communication signal, are identified. For example, in the contact details display 200, if line 240 indicates that a vocal parameter is stored for the individual associated with the contact details display 200; and line 245 indicates that a vocal alert for the individual is activated; then the mobile telephone 100 evaluates whether the incoming communication signal is associated with a voice call, a text message, a multimedia message, or an email. If the incoming communication signal is from, of example, an email address identified at line 225 of the contact details display for the individual; then a vocal parameter file described at line 250 of the contact details display 200, and a pre-defined phrase described at line 315 of the vocal details display 300 are identified as being associated with the incoming communication signal.

At block 520, speech is synthesized using the vocal parameter and the pre-defined phrase to emit the audible alert over a speaker associated with the wireless communication device. For example, continuing the example above, if line 410 of the ring tone styles display 400 indicates that vocal alerts should be used, then an audible alert is played over the communications speaker 122 of the mobile telephone 100, indicating that an email has been received from the individual identified at line 205 of the contact details display 200. Thus if line 205 lists the name of a boss of a user of the mobile telephone 100, then the audible alert may utter the phrase “new email from your boss”, the text of which, having been pre-defined by the user, is listed at line 315 of the vocal details display 300. Further, such a phrase is uttered using a vocal parameter of the boss so that the audible alert simulates the voice of the boss, who is the email sender, and it sounds to a user of the mobile telephone 100 as if his or her boss is speaking over the communications speaker 122.

Embodiments of the present invention therefore enable significantly more information to be presented in audible alerts concerning incoming communication signals. By simulating actual voice characteristics of a caller, or of a sender of an electronic message, the present invention enables a user of an electronic communication device, such as a mobile telephone or personal digital assistant (PDA), to immediately recognize the identity of the caller or sender. That is because the user may instantly and intuitively recognize the voice signature of the caller or sender, even before hearing or comprehending all the words of a pre-defined phrase uttered as the audible alert. Further, pre-defined phrases that appear to be uttered by a voice of the caller or sender can be defined by the user, and thus such phrases can be authored by the user in a creative, humorous, endearing, or other entertaining or informative style.

It will be appreciated that embodiments of the invention described herein may be comprised of one or more conventional processors and unique stored program instructions that control the one or more processors to implement, in conjunction with certain non-processor circuits, some, most, or all of the functions of emitting an audible alert on a wireless communication device as described herein. The non-processor circuits may include, but are not limited to, a radio receiver, a radio transmitter, signal drivers, clock circuits, power source circuits, and user input devices. As such, these functions may be interpreted as steps of a method for emitting an audible alert on a wireless communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method of emitting an audible alert on a wireless communication device, the method comprising:
identifying a vocal parameter and a pre-defined phrase associated with an incoming communication signal; and
synthesizing speech using the vocal parameter and the pre-defined phrase to emit the audible alert over a speaker associated with the wireless communication device.

2. The method of claim 1, further comprising:
analyzing a voice signal of a caller or callee; and
defining the vocal parameter based on the voice signal of the caller or callee.

3. The method of claim 1, wherein the vocal parameter comprises a vocal frequency and a vocal pitch.

4. The method of claim 1, wherein the vocal parameter and the pre-defined phrase are associated with the incoming communication signal based on a telephone number.

5. The method of claim 1, wherein the pre-defined phrase is stored in a telephone number database associated with the wireless communication device.

6. The method of claim 1, wherein the pre-defined phrase is definable by a user of the wireless communication device.

7. The method of claim 1, wherein the incoming communication signal is associated with a voice call, a text message, a multimedia message, or an email.

8. The method of claim 1, wherein the audible alert simulates a voice of a caller.

9. The method of claim 1, wherein identifying the pre-defined phrase comprises evaluating whether the incoming communication signal is associated with a voice call, a text message, a multimedia message, or an email.

10. A wireless communication device comprising:
computer readable program code components configured to cause identifying a vocal parameter and a pre-defined phrase associated with an incoming communication signal; and
computer readable program code components configured to cause synthesizing speech using the vocal parameter and the pre-defined phrase to emit an audible alert over a speaker associated with the wireless communication device.

11. The device of claim 10, further comprising:
computer readable program code components configured to define the vocal parameter by analyzing a voice signal of a caller or callee.

12. The device of claim 10, wherein the vocal parameter comprises a vocal frequency and a vocal pitch.

13. The device of claim 10, wherein the vocal parameter and the pre-defined phrase are associated with the incoming communication signal based on a telephone number.

14. The device of claim 10, wherein the pre-defined phrase is stored in a telephone number database associated with the wireless communication device.

15. The device of claim 10, wherein the pre-defined phrase is definable by a user of the wireless communication device.

16. The device of claim 10, wherein the incoming communication signal is associated with a voice call, a text message, a multimedia message, or an email.

17. The device of claim 10, wherein the audible alert simulates a voice of a caller.

18. The device of claim 10, wherein identifying the pre-defined phrase comprises evaluating whether the incoming communication signal is associated with a voice call, a text message, a multimedia message, or an email.
